(19) United States
(12) Patent Application Publication
(10) Pub. No.: US 2026/0051693 A1
(43) Pub. Date: Feb. 19, 2026

(54) SEALED ELECTRICAL CONNECTOR ASSEMBLY

(71) Applicant: Aptiv Technologies AG, Schaffhausen (CH)

(72) Inventors: Uvaraj GANESAN, Tamil Nadu (IN); Romain SAVINA, Saint Martin de (FR); Sylvain LOAS, Le Gault Saint Denis (FR); Laurent DELESCLUSE, Saint Piat (FR)

(21) Appl. No.: 19/299,773

(22) Filed: Aug. 14, 2025

(30) Foreign Application Priority Data
Aug. 14, 2024 (EP) 24194582.3

(51) Int. Cl. H01R 13/52; H01R 13/629

(52) U.S. Cl. CPC H01R 13/5219; H01R 13/62944

(57) ABSTRACT

An electrical connector assembly includes a sealed connector housing having a side wall with an inner side wall and a parallel outer side wall defining a gap therebetween. A mate assist lever with at least one first gear wheel element is mounted within the gap between the inner and outer side walls, positioned on the inner side of the outer side wall. The lever is arranged to maintain a clearance between itself and the outer side of the inner side wall, the clearance being configured to allow insertion of a portion of a housing of a counter-connector assembly. This arrangement facilitates guided mating of the connector assembly while maintaining sealing integrity.

### CROSS-REFERENCE TO RELATED APPLICATION

This application claims the benefit of and priority to European Application No. 24194582.3 filed with the European Patent Office on Aug. 14, 2024, the contents of which are incorporated by reference herein.

### TECHNICAL FIELD

The present disclosure generally relates to an electrical connector assembly.

Particularly it relates to an electrical connector assembly including connector modules from a set of connector modules that is releasably connected to a corresponding electrical counter-connector assembly by operation of a lever of the electrical connector assembly.

### BACKGROUND

A common “lever-type” electrical connection includes an assembly of a first connector assembly or housing and a second connector assembly or header. To mate the connector assemblies together, the connection has an actuating or assist lever mounted for pivoting on the first connector assembly, with pivoting of the lever causing the first and second connector assemblies to shift between unmated and fully mated configurations. For example, the actuating lever and the second connector assembly may have a cam groove and a cam follower arrangement for drawing the second connector assembly into mating condition with the first connector assembly in response to pivoting of the lever. Such connectors are commonly used in the automotive industry but require complex mechanics.

A typical example for such lever-type electrical connections is to provide a generally U-shaped lever structure having a pair of relatively thin-walled lever sidebars that are disposed on opposite sides of the housing connector. The lever sidebars may have cam grooves for engaging cam follower projections or posts on opposite sides of the header assembly. These types of lever connectors are often used where relatively large forces are required to mate and un-mate a pair of connector assemblies. For instance, frictional forces encountered during connecting and disconnecting the connector assemblies may make the process difficult to perform by hand. In some cases, relatively large electrical connectors with high pin counts, such as connectors with 90 or more pin contacts, require at least about 300 N to mate or un-mate. Further, automotive industry standards specify a maximum of 75 N of user input force to perform this mating and un-mating of the connectors.

A problem with prior lever-type electrical connection assemblies is that, because of the position of the lever, no seal can be placed between the first connector assembly and the second counter-connector assembly. As a result, these lever-type connectors cannot readily be used for sealed connections but require sophisticated or complex scaling solutions.

The object of the present disclosure is to overcome some or all the disadvantages of the prior art connectors, and particularly to provide a sealed electrical connector that is safe in use, can be mated and un-mated with little effort, provides a reliable design, can be easily mounted and has only a small footprint.

### SUMMARY

The above-mentioned objectives may be realized by an electrical connector assembly including a sealed connector housing, with a sidewall including an inner sidewall and a parallel outer sidewall, defining a gap therebetween; and a mate assist lever including at least a first gear wheel element, the lever being mounted between the inner sidewall and the outer sidewall on the inner side of the outer sidewall, such that a clearance remains between the lever and the outer side of the inner sidewall, the clearance being adapted to allow insertion of a part of a housing of a counter-connector assembly.

In other words, the lever is mounted on the gap-facing, inner side of the outer sidewall. The inner sidewall remains free from any attachment mechanism that could compromise the proper sealing of the connector housing.

Preferably, the connector housing includes two to eight slots for holding a corresponding number of connector modules from the set of connector modules. Thus, the electrical connector can be easily configured for a multitude of different contact options.

In a preferred embodiment, the sealed connector housing includes two opposing sidewalls, each sidewall including an inner sidewall and a parallel outer sidewall, defining a gap therebetween. Even though two sidewalls with gaps are not strictly necessary, it allows a symmetrical connection of the lever to better distribute the mating forces on the assembly and for the user. Better distributed mating forces also reduce the force applied on the interface between housing and lever.

A preferred embodiment of the mate assist lever allows such a symmetrical connection. In this embodiment, the mate assist lever is a U-shaped lever, including a crossbar and two sidebars extending from the ends of the crossbar. A set of first gear wheel elements is connected at a respective end of each sidebar. The first gear wheel elements together with the ends of each sidebar are respectively mounted between the inner sidewall and the outer sidewall on the inner side of the outer sidewall.

Mating the electrical contacts of the electrical connector assembly with the counter-connector assembly can require high mating forces. For example, a 0.50 26-way module may have a mating force of 65 N, whereas a 2.80 4-way module may have a mating force of 40 N. The mating force applied by the user on the crossbar of the lever is distributed on both sidebars, thereby facilitating the mating process. Furthermore, as the lever is designed to assist mating, the assistance will occur on both sides of the lever and the connector housing, thereby ensuring a symmetrical, straight mating with the counter-connector assembly, which is not prone to tilting during mating.

However, different connector modules in one connector may also generate a disbalance of the mating force over the mating surface. The U-shaped lever can compensate for this disbalance to facilitate mating.

Another way to distribute the mating force of the connector assembly with the counter-connector assembly is to add at least one second gear wheel element to the connector assembly. The second gear wheel element is associated with the first gear wheel element and configured to assist mating of the connector assembly with the counter-connector assembly.

Since the second gear wheel is associated with the first gear wheel, any movement of the lever will also induce a movement of the at least one second gear wheel. Obviously, in a symmetrical arrangement, the connector assembly can include two second gear wheel arranged in the gap of the opposing sidewalls.

Preferably, the second gear wheel elements mesh with and are driven by the first gear wheel elements. Thus, the second gear wheel elements rotate in opposite direction with the first gear wheel elements when the lever is rotated.

In a preferred embodiment the at least one second gear wheel element is a gear wheel segment, preferably at most a half wheel, even more preferably a quarter wheel. Limiting the gear wheel element to a wheel segment has the advantage of having a limited space requirement while keeping a sufficient radius of the gear wheel element to leverage the mating forces from the lever to the counter-connector housing. In any case, because the lever only can perform a limited rotation in use, the second gear wheel is also limited in its rotation and does not need to function on its whole circumference such that a segment is typically enough.

To associate the at least one first gear wheel element with the at least one second gear wheel element, they advantageously each include a set of first gear teeth for meshing with the set of first gear teeth of the respective other gear wheel element.

To associate the at least one first gear wheel element and/or the at least one second gear wheel element with the counter-connector assembly, at least one of the gear wheels elements may include a set of second gear teeth which is adapted for meshing with a teethed rack of an electrical counter-connector assembly. To make the connection it is sufficient that the second gear teeth include one full tooth and two halve teeth, although more teeth are possible. Preferably second gear teeth are added to each of the first gear wheel elements and to each of the second gear wheel elements such that the counter-connector assembly is biased into mating on at least two different points on each side of the connector assembly. Further, since a set of gear teeth is used to mesh with a teethed rack of the counter-connector assembly the force introduction during the mating procedure is always parallel to the mating direction. Thus, no lateral forces apply to the electrical connector which would increase the friction during the mating procedure. This prevents the counter-connector assembly from being tilted during assembly and the mating process being blocked due to a crooked positioning of the counter-connector assembly.

Thus, the gear wheel elements can include a “double gear configuration”, integrating two different gear wheels into one. The first gear wheel elements each include a first set of gear teeth for meshing with second gear wheel elements. Further, the first gear wheel elements each include a second set of gear teeth for meshing with a teethed rack of a counter electrical connector.

The first set of gear teeth can include a first rotation radius of the first gear wheel elements around the first rotation pins; and the second set of gear teeth can include a second rotation radius of the first gear wheel elements around the first rotation pins. The first rotation radius can thereby be different from the second rotation radius. In any event, the rotation radiuses can be adapted to the necessary mating force and travel necessary. The smaller the first rotation radius, or the length, of the first set of gear teeth is selected the larger the mating force will be, when the lever is rotated. Further, the mating of gear teeth with a teethed rack provides a rolling contact of the contact faces what generates almost no friction. Therefore, the force introduced by the lever is almost fully transmitted into a mating or un-mating force without significant losses, like the friction that is generated in prior art designs.

Further, the second set of gear teeth includes a second rotation radius of the first gear wheel elements around first the rotation pins. The first rotation radius can be different to the second rotation radius. In fact, the second rotation radius can be selected according to the desired distance between the first gear wheel elements and second gear wheel elements that are driven by the first gear wheel elements and the lever. Preferably, the second gear wheel elements also introduce a mating force between the electrical connector assembly and its counter-connector assembly. The larger the second rotation radius will be, the larger the distance of the force introduction points will be, which provides a good balance of the mating forces. Preferably, the electrical connector assembly provides four force introduction points, two on each lateral side of the electrical connector assembly, which are distanced from each other to ensure a parallel mating of the electrical connector assembly and its counter-connector assembly by rotating the lever.

The sealed connector housing preferably includes a seal at least partially arranged in the gap to create a tight, sealed connection with the counter-connector assembly when the connector assemblies are mated. The seal seals the connection between connector assembly and counter-connector assembly at a determined point. The seal can be inserted into a groove on the inner sidewall of the connector assembly and be held within the groove by means of a fin inserted into the groove. Advantageously the seal surrounds the connector housing at a location designed to receive an end region of the counter-connector assembly. This way no potential gaps due to misplacement of the seal can occur because the seal covers a whole perimeter. It is further possible to place the seal under a certain pretension by dimensioning the seal slightly smaller than the perimeter of the connector assembly to be covered, and by choosing the right material for the seal.

In a preferred embodiment, the at least one sidewall is connected to pocket-like edge walls at each sidewall end. In analogy to the sidewall, each edge wall includes an inner edge wall and an outer edge wall. The inner sidewall is connected to the inner edge wall and the outer sidewall is connected to the outer edge wall. Furthermore, the edge wall includes an edge wall connection connecting the inner edge wall to the outer edge wall and defining a pocket space. The pocket space is open in mating direction of the connector assembly with the counter-connector assembly such that at least a part of the housing of the counter-connector assembly can be inserted into the pocket space. By designing doubled edge walls in analogy with the sidewalls, it is possible to mate the connector assembly with a counter-connector assembly having a straight edge. Consequently, inner side walls, outer side walls, and edge walls are held together by the edge wall connections.

The at least one gap of the sidewall may have a substantially rectangular cross-section and be open towards the bottom and the top of the gap. The opening on the bottom allows the insertion of the counter-connector assembly while the opening on the top allows the insertion of the lever and the associated mechanism, such as a second gear wheel element. The gap is dimensioned to accommodate the lever mechanism and part of the wall of the counter-connector assembly. In particular, the gap can be dimensioned to urge the edge of the counter-connector walls against the inner walls of the connector assembly, for example where the seal is protruding.

Alternatively, the gap can also be tapered to urge the edge of the counter-connector assembly against the sidewall of the connector assembly in the mating process.

Similarly, the pocket space of the edge walls can have a substantially rectangular cross-section or be tapered in mating direction. The pocket space of the edge wall is however only open towards the bottom to allow assembly with the counter-connector, the top being the edge wall connection connecting the inner and outer walls of the whole connector assembly.

To connect the gear wheel elements to the outer sidewall and simultaneously allow the rotation of the gear wheel elements, the gear wheel elements are connected to the inner side of the outer sidewall by means of a respective rotation pin defining the rotation axis of the gear wheel element. Depending on the circumstances, different options are possible for the rotation pin. One option is to make the rotation pin integral with the respective gear wheel element while the outer sidewall has a hole to accommodate the rotation pin. Another option is to make the rotation pin integral with the inner side of the outer sidewall. In such a case the gear wheel element itself has a hole to accommodate the rotation pin. In the third option the rotation pin is a separate element which is accommodated in a hole of the gear wheel element and a hole in the inner side of the outer sidewall.

Preferably, snap in features make sure that the separate rotation pin does not slide of engagement with the gear wheel element or the sidewall. As such the rotation pins include integral locks for respectively holding the rotation pins on the gear wheel elements and/or the outer sidewalls. Thus, the first and/or second gear wheel elements are securely held on the respective rotation pins without additional mounting means, which could be lost or must be manually attached.

The first rotation pins are conveniently offset from the center of the outer sidewalls seen in longitudinal extension direction of said walls. The longitudinal extension direction of the walls is perpendicular to the mating direction of the connector. By arranging the rotation pins offset from the center, it is possible to increase the length of the effective lever arm, compared to e.g., a central location of the rotating pins, without increasing the overall space required for the connector.

The lever can be easily mounted to the connector housing without complex mounting steps or excessive bending of the sidebars by inserting the respective pins into the hole of the outer sidewall of the connector housing or a hole in the first gear wheels of the lever. The generally flat design of the sidebars also facilitates force transmission from the manually actuated crossbar via the two sidebars to the integral first gear wheel elements. Thus, the overall lateral dimension of the electrical connector is decreased compared to the more complex prior art designs.

In a preferred embodiment, the outer sidewall on which the at least first gear wheel element and the at least second gear wheel element are mounted includes a first hole, which is elongated following an elongation axis, and a rotation point, or second hole located at a distance from the first hole in the direction of the elongation axis. The rotation pin of the at least one first gear wheel element extends through the first elongated hole, the at least one second gear wheel element is associated to a rotation pin extending from the rotation point or through the second hole. When the first gear wheel element is mounted at a first end of the elongated hole, the sets of first gear teeth of first and second gear wheel elements are in meshing engagement, and when the first gear wheel element is mounted at a second end of the elongated hole, the sets of first gear teeth of the first and second gear wheel elements are out of engagement. When at least the first hole, to which the rotation pins of the gear wheel elements of the lever are connected, is an elongated hole, the step of inserting and positioning the gear wheels within the gap in the sidewall is separated from the step of meshing the first gear wheel elements with the second gear wheel elements. This facilitates the mounting of the lever and the second gear wheel elements on the outer sidewall and their correct positioning to ensure that the lever action is properly translated into a mating force.

The above-mentioned objectives are further realized by a mating assembly including an electrical connector assembly and a counter-connector assembly. With the assistance of the lever, the counter-connector is configured to be mated with the electrical connector assembly to create an electrical connection.

To allow lever assisted mating of the counter-connector assembly with the connector assembly, the counter-connector assembly may include teethed racks that mesh with first sets of second gear teeth of the first gear wheel elements and/or second sets of second gear teeth of the second gear wheel elements. As mentioned above, when a set of gear teeth from gear wheel elements from the connector assembly is used to mesh with a teethed rack of the counter-connector assembly, the force introduction during the mating procedure is always parallel to the mating direction. Thus, no lateral forces apply to the electrical connector which would increase the friction during the mating procedure.

When the connector assembly is mated with the counter-connector assembly, the gap of the connector housing accommodates the gear wheel elements, and the remaining clearance within said gap basically corresponds to the thickness of the walls of the counter-connector assembly, such that the counter-connector assembly is fittingly mated with the connector assembly.

Preferably, the electrical connector assembly further includes a cover attached to the top side of the connector housing. The cover includes a cover latch that latches with the connector housing, when the lever is in a fully closed position in which the electrical connector assembly fully engages its counter electrical connector assembly. The cover together with the lever maintains the electrical connector assemblies securely mated even in rough conditions, i.e., in automotive applications. For even more security, the electrical connector assembly can include a connector position assurance (CPA)-element ensuring the right positioning of the cover and the lever and blocking the lever in latched engagement.

### BRIEF DESCRIPTION OF THE DRAWINGS

In the following, preferred embodiments of the disclosure are disclosed by reference to the accompanying figure, in which shows:

FIGS. 1A to 1C are isometric views of the lever-type connector assembly according to the prior art showing the steps of connecting the lever and gear wheel elements to the step in which the lever is in the fully mated position.

FIG. 2 is a first exploded view of the main components of an embodiment of the electrical connector assembly of the disclosure.

FIG. 3 is a second exploded view of the main components of another embodiment of the electrical connector assembly of the disclosure together with other components of the connector assembly.

FIG. 4 is a third exploded view of the first embodiment of the electrical connector of the disclosure.

FIG. 5 is an isometric view of the assembled, first embodiment of the electrical connector of the disclosure with the lever in the fully mated position.

FIG. 6 is a cross-sectional view through the connector housing in a first plane.

FIG. 7 is a cross-sectional view through the connector housing, the cover, and the lever in a second plane perpendicular to the first plane of FIG. 6.

FIGS. 8A to 8D are detailed views of a second, elongated hole and the rotation pin of the second gear wheel elements. The rotation pin is shown in the inserted, first position, where the gear wheel elements are not meshed, and in a rotated, second position, where the gear wheel elements can be meshed.

FIGS. 9A and 9B are detailed views of a first, elongated hole and the rotation pin of the first gear wheel elements in the first position, where the gear wheel elements are not meshed, and in the second position, where the gear wheel elements can be meshed.

FIGS. 10A and 10B are side views of first and second gear wheel elements in a non-meshed position with the lever in a pre-stop position. The gear wheels are shown in a sectional view and from the outside.

FIGS. 11A and 11B are side views of first and second gear wheel elements in a meshed position with the lever in a pre-stop position. The gear wheels are shown in a sectional view and from the outside.

FIGS. 12A and 12B are isometric views of first and second gear wheel elements in a meshed position with the lever in the fully mated position. The gear wheels are shown in a sectional view and from the outside.

FIG. 13 is a side view of another embodiment of the connector assembly showing an alternative mounting sequence to the one shown in the details of FIGS. 11A to 12B.

FIG. 14 is a cross-sectional view of the embodiment of FIG. 13 showing the mounted and meshed gear wheels with the lever in the fully mated position.

FIG. 15 is a cross-sectional view of a mating assembly showing the connector assembly, the meshed gear wheels with the lever in the pre-lock position and the counter-connector assembly ready to be mated with the connector assembly.

### DETAILED DESCRIPTION

In the following, preferred embodiments of the present disclosure are described in detail with respect to the figures.

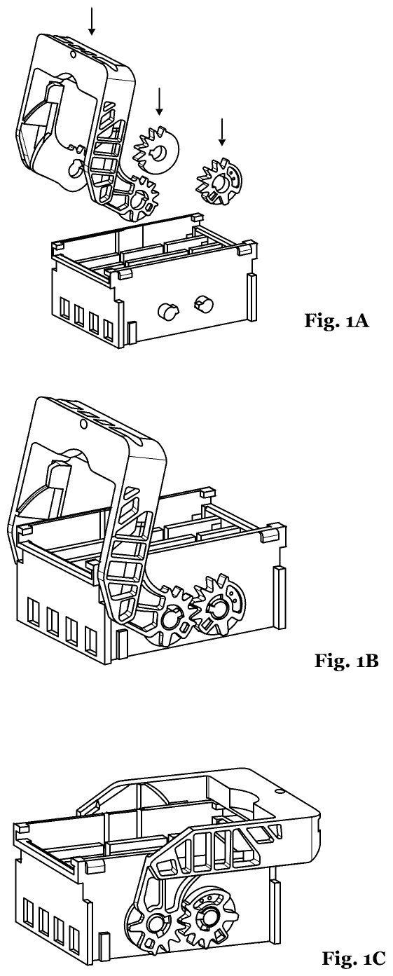

In FIGS. 1A to 1C isometric views of a lever-type connector assembly according to the prior art show the steps of connecting the lever and gear wheel elements (see FIG. 1A), the pre-stop position, in which the counter-connector can be mated with the connector housing of the connector assembly (see FIG. 1B) and the step in which the lever is in the fully mated position (see FIG. 1C). A counter-connector assembly is not shown in FIGS. 1A to 1C.

The lever, and in particular the U-shaped lever has the advantage of reducing the mating forces that the user needs to apply to mate the connector assembly with the counter-connector assembly.

The first gear wheel elements of the lever and the second gear wheel elements are connected to the connector housing with rotation pins disposed on the outside of the connector housing. Because of this configuration, when a counter-connector assembly is mated with the connector assembly, the gear wheel elements are located between the connector housing and the housing of the counter-connector. It is not possible to seal the space between the sidewall of the connector assembly and the sidewall of the counter-connector assembly because the lever and the gear wheel elements rotate and change position during mating of the connector assembly to the counter-connector assembly.

The present disclosure proposes an electrical connector assembly that can be mated with a counter-connector assembly while sealing the interface between the connector assembly and the corresponding counter-connector assembly.

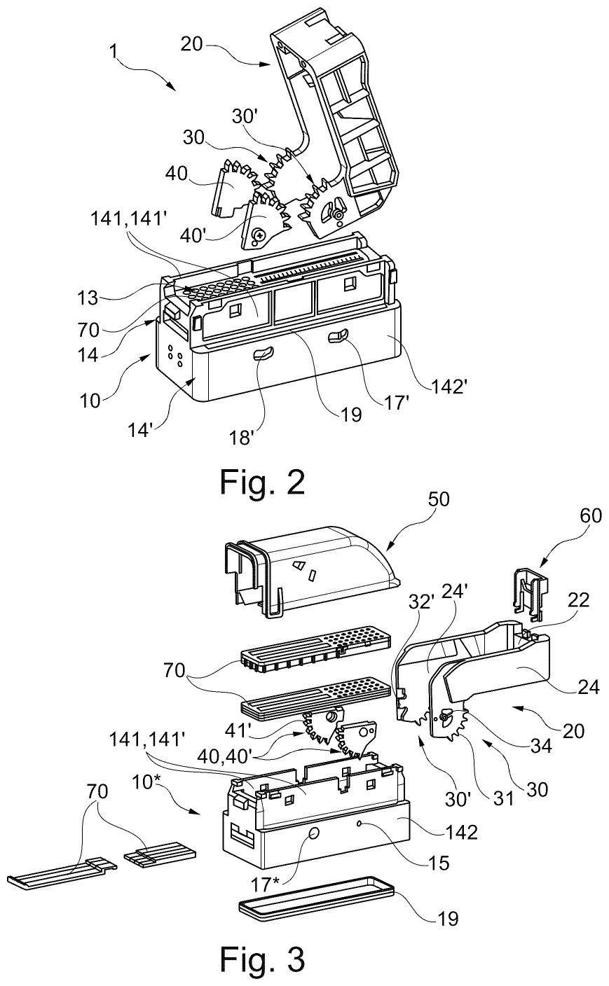

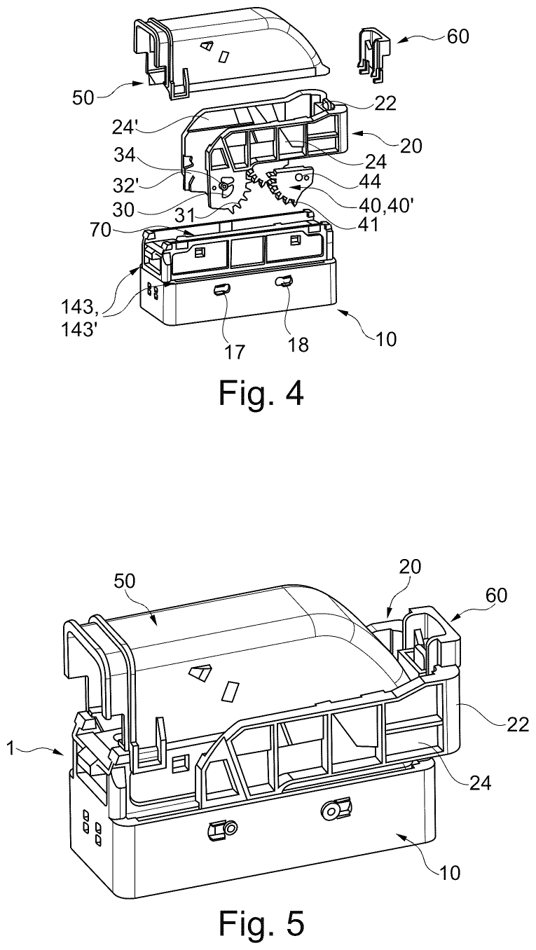

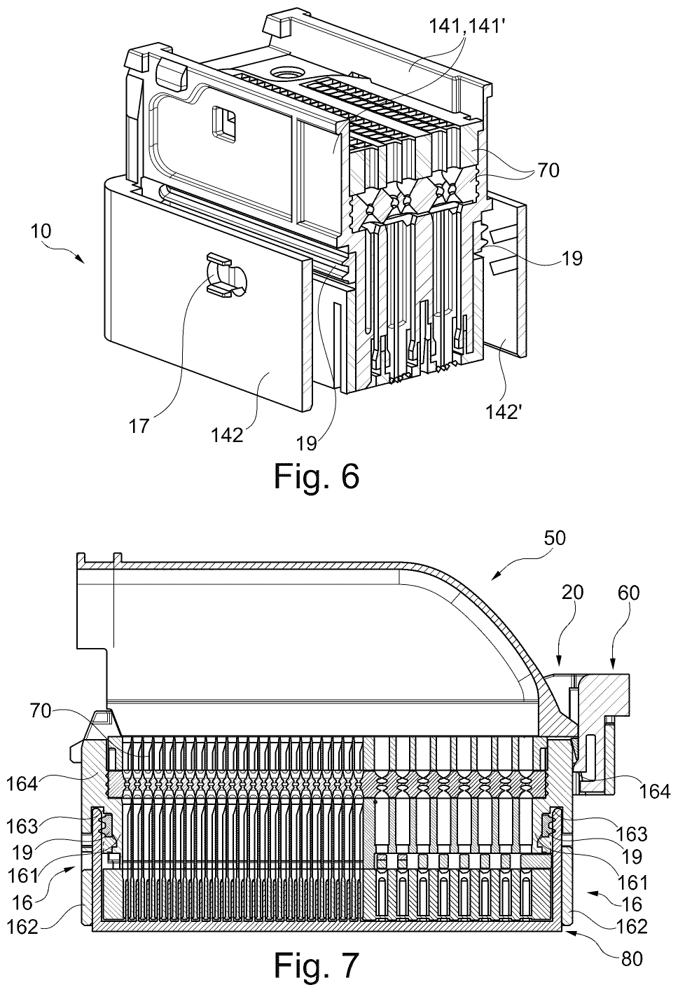

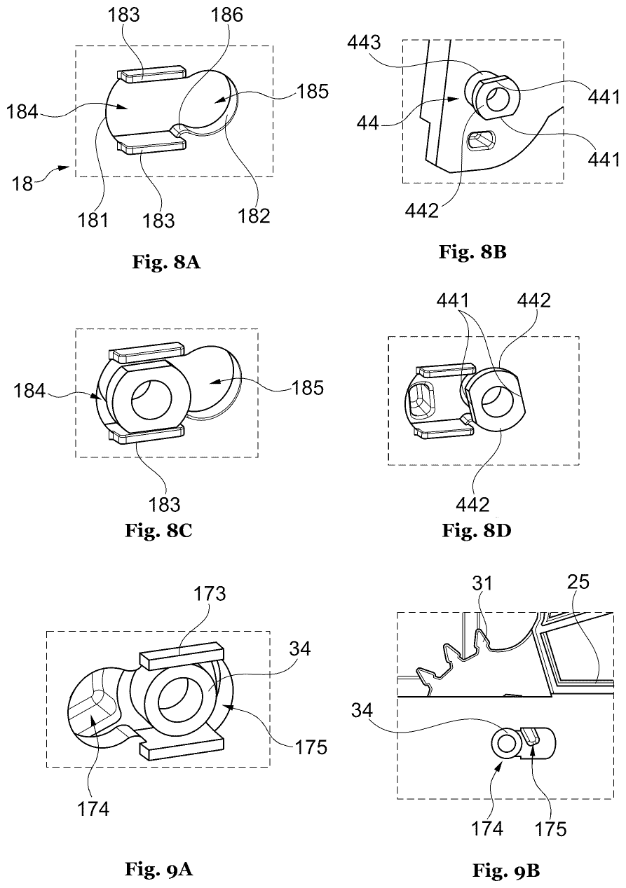

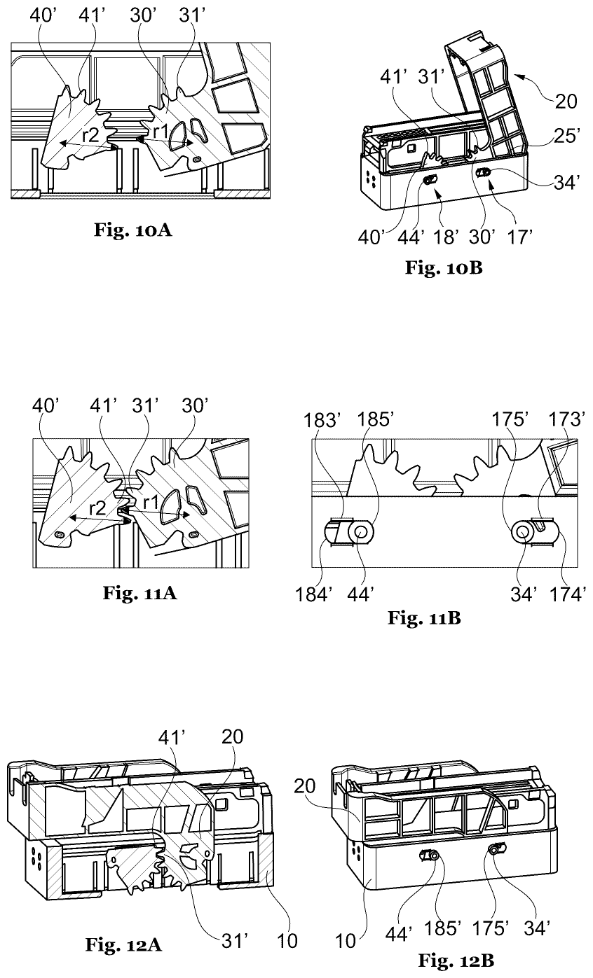

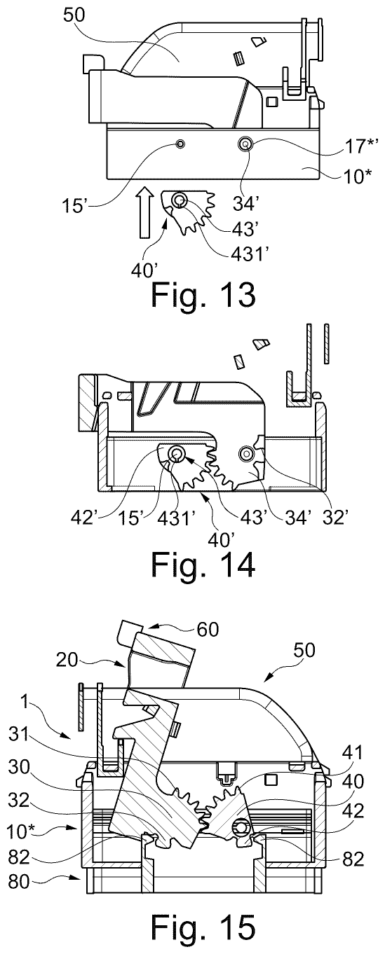

FIG. 2, FIG. 4, FIG. 5, FIG. 6, FIGS. 8A-D, FIGS. 9A & 9B, FIGS. 10A & 10B, FIGS. 11A & 11B, and FIGS. 12A & 12B show a first preferred embodiment of an electrical connector assembly of the invention. FIG. 3, FIG. 13, FIG. 14, and FIG. 15 show a second preferred embodiment of an electrical connector assembly of the invention. FIG. 7 applies to both embodiments. Even though both illustrated embodiments have a U-shaped lever and second gear wheel elements, these elements are not necessary.

As shown in the three-dimensional, exploded view of FIG. 2, the electrical connector assembly 1 includes a connector housing 10, a mate assist lever 20 pivotably connectable to the connector housing 10, and a pair of second gear wheel elements 40, 40′. The lever 20 includes a first set of gear wheel elements 30, 30′. The housing 10 includes sidewalls 14, 14′ each having an inner sidewall 141, 141′ and an outer sidewall 142, 142′ defining a gap 143, 143′ therebetween. The housing 10 includes a main slot 13 adapted to receive connector modules 70. The outer sidewalls 142, 142′ are provided with first 17, 17′ and second 18, 18′ holes for pivotable receiving rotation pins of the wheel elements.

FIG. 3 shows an exploded view of a second embodiment of an electrical connector assembly that differs from the one of FIG. 2 in the attachment of the lever and the second gear wheel elements 40, 40′ to the connector housing 10*. The view of FIG. 3 is rotated by 180° with respect to the view of FIG. 2. In particular, the position of the lever 20 is reversed with respect to the position of the lever in FIG. 2. In both embodiments the lever 20 is connected to first holes 17, 17′ of the connector housings 10* and 10, respectively. The connector housing 10* further includes a rotation pin 15 which is integral with the outer sidewall 142. In this view one can further see the seal 19 in the form of a closed loop.

FIG. 4 shows the connector assembly 1 of FIG. 2 rotated by 180°. One can see that the assembly is symmetrical and in the drawings the apostrophe of a reference sign indicates the respective symmetrical counterpart. The assembly further includes a cable cover 50 and a CPA element 60 for additional locking of the lever in the mated position. The lever 20 is U-shaped having a crossbar 22 and two parallel sidebars 24, 24′. The distal ends of the sidebars are respectively provided with the gear wheel elements 30, 30′ including a first set of first gear teeth 31 and first rotating pins 34, 34′ that fit into the first holes 17, 17′. Likewise, the second gear wheel elements 40.40′ include a second set of first gear teeth 41 and are provided with second rotation pins 44, 44′ that fit into the second holes 18, 18′. The lever and the second gear wheel elements are mounted in the gap 143, 143′.

FIG. 5 shows the same view as FIG. 4 with the connector assembly being assembled. The lever 20 is in the mated position.

FIG. 6 shows a 3D cut view of the connector housing 10. One can see the position of the seal 19. The seal is a closed loop surrounding a perimeter of the inner sidewall 141, 141′ at the location where the edge of the housing of the counter-connector assembly comes to rest in the fully mated position. The seal 19 can be made of rubber and/or silicon.

FIG. 7 shows a cut side view of the connector assembly 1 in fully mounted condition with a counter-connector assembly 80. FIG. 7 applies to both embodiments. One can see pocket-like edge walls 16. Each edge wall 16 includes an inner edge wall 161, an outer edge wall 162 and an edge wall connection 164 connecting the inner edge wall 161 to the outer edge wall 162 thereby defining a pocket space 163. Pocket space 163 is open in mating direction of the connector assembly 1 with the counter-connector assembly 80 such that a part of the housing of the counter-connector assembly 80 can be inserted into the pocket space 163 and the gap 143, 143′. Pocket space 163 is in communication with the gap 143, 143′.

The details of the pin-hole connection according to the first embodiment are shown in FIGS. 8A to 9B, the mounting of the gear wheel elements of the first embodiment is shown in FIG. 10A to 12B.

The functionality of the elongated holes will now be described taking hole 18 as an example. The skilled person will understand that the teaching is applicable to all three holes. The general shape of the elongated hole 18 (and thus also 17, 17′ and 18′) according to the first embodiment is shown in FIG. 8A. The elongated hole 18 includes a housing slot 184 located at the first end 181 of the elongated hole 18 and a pivot hole 185 located at the second or opposite end 182 of the elongated hole 18. The housing slot 184 preferably has flat faces 183 that cooperate with a flat feature 441 of the respective rotation pin 44 such that the gear wheel element 40 can only be inserted into the elongated hole 18 in a predefined orientation. The flat faces 183 of the housing slot 184 are flat in the direction of the elongated axis of the elongated hole 18 and protruding from the face of the outer sidewall 142. They also block the unwanted rotation of the gear wheel elements 40 when the gear wheel elements 40 are mounted to the connector housing in the housing slot 184. More generally, the shape of the flat face 183 protruding from the face of the outer sidewall 142 is complementary to the shape of the second rotation pin 44 of the second gear wheel elements. The elongated holes include a locking bump 186 designed to keep the pin 44 within the pivot hole 185.

When the rotation pin 44 is moved from the housing slot 184 located at the first end 181 of the elongated hole 18 to the pivot hole 185 located at the second end 182 of the elongated hole 18, it passes the locking bump 186 designed to keep the pin 44 within the pivot hole 185. To pass the locking bump 186 a certain resistance needs to be overcome until the pin 44 clicks into the pivot hole 185. This ensures that the pin does not travel back in rough conditions such as automotive applications. This is important as the gear wheel elements 40 are in meshing engagement only when the rotation pins 44 are in the pivot hole. The consequence of a pin 44 traveling back is that the second gear wheel elements will be unmeshed from the first gear wheel elements. Consequently, because the second gear wheel elements are held in mating position via the lever, which is latched to the connector housing, and because the lever docs not hold the second gear wheel element when unmeshed, the mating engagement of the connector assembly and the counter-connector assembly can loosen and create a safety issue.

As shown in FIG. 8B, pin 44 has a flat feature 441 that cooperates with the flat face 183 of the connector housing 10, to ensure correct positioning of the second gear wheel elements. The flat feature 441 allows insertion of the second rotation pin 44 into the housing slot 184 only in a predetermined position as can be seen in FIG. 8C. The pin 44 further has a holding skirt 442, which has flaps protruding from the cylindrical pivot 443 of the pin 44.

As shown in FIG. 8D, once the pin 44, 44′ of the second gear wheel 40, 40′ is in the pivot hole 175, 175′, 185, 185′, it is held in place by means of holding skirt 442, 442′. The outer sidewall 142, 142′ is thereby sandwiched between the holding skirt 442, 442′ and the second gear wheel segment and cannot drop out of engagement if for example subjected to vibrations.

In FIGS. 9A & 9B, which shows the pivot attachment of the lever, it is visible that such a holding skirt is not required when the first gear wheel elements are connected to the connector housing, as the U-shaped lever 20 with the side bars 22 prevent any disengagement of the first gear wheels 30, 30′ with the outer sidewall 142, 142′. To mount the lever 20 on the connector housing 10, the rotations pins 34, 34′ are inserted into the elongated holes 17, 17′ by pressing the sidebars 24, 24′ together and inserting them into the gap 143, 143′ of the sidewall 14, 14′. Thus, the rotation pins 34, 34′ are inserted under pre-tension and will not drop out of engagement.

In practice, the first elongated hole 17, 17′ does not require flat faces 173, 173′ for a correct positioning of the lever. It does not even need to be elongated, although the elongated hole has the advantage of splitting the mounting step of the lever 20 on the connector casing 10 from the step of bringing the gear wheel elements 30, 30′, 40, 40′ into meshing engagement, thereby allowing a facilitated, better controlled positioning. Similarly, no second elongated hole 18, 18′ is strictly required to be able to mount the second gear wheel elements 40, 40′. Having a connector housing with two elongated holes 17, 17′, 18, 18′ however has the advantage that the connector housing can be used in both directions, where the lever and the second gear wheel elements can be installed in any of the pair of elongated holes. Such a configuration can therefore avoid mounting errors.

As shown in FIGS. 10A & 10B, to mount the lever mechanism onto the connector housing 10, the rotation pins 34, 34′ of the gear wheel elements 30, 30′ of the lever 20 are mounted in the elongated holes 17, 17′. On the other side of the connector housing 10, the second rotation pins 44, 44′ of the second gear wheels 40, 40′ are mounted in holes 18, 18′. As shown in FIG. 10A, the first gear wheel elements 30, 30′ define a first rotation radius r1 and the second gear wheel elements 40, 40′ define a second rotation radius r2. In the shown position the first gear teeth 31, 31′ of the first gear wheel elements 30, 30′ do not mesh with the first gear teeth 41, 41′ of the second gear wheel elements 40, 40′, because the distance between the first end 171, 171′ of the first elongated hole 17, 17′ and first end 181, 181′ of the second hole 18, 18′ is greater than the sum of first rotation radius r1 and second rotation radius r2.

When the first and the second gear wheel elements 30, 30′, 40, 40′ are pushed into the pivot holes 175, 175′, 185, 185′ on the second ends 172, 172′, 182, 182′ of the first and second, elongated holes 17, 17′, 18, 18′, as shown in FIGS. 11A & 11B, the first gear teeth 31, 31′, 41, 41′ of the first and second gear wheel elements 30, 30′, 40, 40′ will mesh. In this position, the distance between the second end 172, 172′ of the first elongated hole 17, 17′ and the second hole 18, 18′ is smaller than the sum of the first rotation radius r1 and the second rotation radius r2.

In FIGS. 10A and 10B and FIGS. 9A and 9B, the first and second gear wheel elements 30, 30′, 40, 40′ are in a pre-stop position when they are pushed into meshing engagement. Because only segments of gear wheels are used for the gear wheel elements, not any meshing position of the gear wheel elements will allow a subsequent rotation of the lever into the fully mated position. To ensure the correct positioning of the lever, it has a pre-stop abutment 25, 25′ resting on the edge of the connector housing 10, thereby defining the lever position when sliding the lever from the housing slot 174, 174′ of the first, elongated hole 17, 17′ (as shown in FIG. 10B) to the pivot hole 175, 175′ of the first, elongated hole 17, 17′ (see FIG. 11B).

In the second preferred embodiment, shown in FIG. 3, FIG. 13, FIG. 14, and FIG. 15, a combination of rotation pins 34, 34′ integral with the lever and rotation pins 15 integral with the connector housing is shown. FIG. 13 and FIG. 14 show the mounting procedure, which differs from the mounting procedure of the first preferred embodiment described above. While the lever can be snapped into holes 17*, 17*′, a rotation hole 43, 43′ of the second gear wheel 40, 40′ is connected to the rotation pin 15, 15′ on the connector housing 10*. The gear wheel 40, 40′ has a coding 431, 431′ that determines the position in which it can be connected to the rotation pin 15 to ensure a correct meshing of the first gear teeth 31, 31′, 42, 42′. Contrary to the first embodiment, where the meshing of the gear wheel elements occurs in the pre-stop position of the lever, in the second, preferred embodiment, the gear wheel elements are meshed in the fully mated position of the lever 20. In practice, it is important that the first gear wheel element 30, 30′ is correctly positioned with respect to the second gear wheel element 40, 40′. Once the gear wheel element 40, 40′ is introduced from below in the gap 143, 143′ of the sidewall 14, 14′ and in the correct position, it is pushed onto the rotation pin 15, 15′.

FIG. 14 is cut side view showing the meshing of the gear wheels of the embodiment of FIG. 13. The second gear wheel elements 40, 40′ include a second set of gear teeth 42, 42′ respectively, to engage with teethed racks 82, 82′ of the counter-connector assembly. Similarly, the first gear wheel elements 30, 30′ include a first set of second gear teeth 32, 32′ respectively, to engage with teethed racks 82, 82′ of the counter-connector assembly.

The interaction with the teethed racks 82, 82′ of the counter-connector assembly 80 is shown in FIG. 15. By rotating the lever 20, the teeth 31 engage the teeth 41 and the second gear wheel element 40 is rotated. Both, the first gear wheel element 30 and the second gear wheel element 40 engage with the teeth rack 82, thereby pulling the two connector housings towards each other in mating engagement.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

### LIST OF REFERENCE SIGNS

1 electrical connector assembly
10 connector housing
11 primary locking means
13 main slot
14, 14′ sidewall
141, 141′ inner sidewall
142, 142′ outer sidewall
143, 143′ gap
15 rotation pin integral with the outer wall
16 edge wall
161 inner edge wall
162 outer edge wall
163 pocket space
164 edge wall connection
17, 17′ first hole
171, 171′ first end of first, elongated hole
172, 172′ second end of first, elongated hole
173, 173′ flat faces of first end of first, elongated hole
174, 174′ housing slot of the first, elongated hole
175, 175′ pivot hole of the first, elongated hole
176, 176′ locking bump of the first, elongated hole
18, 18′ second hole
181, 181′ first end of second, elongated hole
182, 182′ second end of second, elongated hole
183, 183′ flat faces of first end of second, elongated hole
184, 184′ housing slot of the second, elongated hole
185, 185′ pivot hole of the second, elongated hole
186, 186′ locking bump of the second, elongated hole
19 seal
20 lever
22 crossbar
24, 24′ sidebars
25, 25′ pre-stop abutment
30, 30′ first gear wheel elements
31 first set of first gear teeth
32 first set of second gear teeth
34, 34′ first rotation pins
40, 40′ second gear wheel elements
41 second set of first gear teeth
42 second set of second gear teeth
43, 43′ rotation hole
431, 431′ positioning cutout
44, 44′ second rotation pins
441, 441′ flat feature
442, 442′ holding skirt
443, 443′ cylinder pivot
50 cover
51 connection means
53 lever abutment
54 lever holding protrusion
60 connector position assurance (CPA)-element
70 connector module
80 counter-connector assembly
82, 82′ teethed rack
r1 radius of the first gear wheel element
r2 radius of the second gear wheel element

1. An electrical connector assembly, comprising:
a sealed connector housing, with a side wall comprising an inner side wall and a parallel outer side wall, defining a gap therebetween; and
a mate assist lever comprising at least one first gear wheel element, the lever being mounted between the inner side wall and the outer side wall on the inner side of the outer side wall, such that a clearance remains between the lever and the outer side of the inner side wall, the clearance being adapted to allow insertion of a part of a housing of a counter-connector assembly.

2. The electrical connector assembly according to claim 1, wherein the sealed connector housing includes two opposing side walls, each side wall comprising an inner side wall and a parallel outer side wall, defining a gap therebetween.

3. The electrical connector assembly according to claim 2, wherein the mate assist lever is a U-shaped lever, comprising a crossbar and two sidebars extending from ends of the crossbar, wherein a set of first gear wheel elements is connected at a respective end of each sidebar, and wherein the first gear wheel elements together with the ends of each sidebar are respectively mounted between the inner side wall and the outer side wall on the inner side of the outer side wall.

4. The electrical connector assembly according to claim 1, wherein the connector assembly further comprises at least one second gear wheel element associated with the first gear wheel element, configured to assist mating of the connector assembly with the counter-connector assembly.

5. The electrical connector assembly according to claim 4, wherein the at least one second gear wheel element is a gear wheel segment, preferably at most a half wheel, even more preferably a quarter wheel.

6. The electrical connector assembly according to claim 4, wherein the at least one first gear wheel element and at least one second gear wheel element each comprises a set of first gear teeth for meshing with the set of first gear teeth of the respective other gear wheel element.

7. The electrical connector assembly according to claim 6, wherein the at least one first and optionally the at least one second gear wheel element is connected to the inner side of the outer side wall by means of a respective rotation pin defining a rotation axis of the gear wheel element, wherein the rotation pin is integral with the respective gear wheel element.

8. The electrical connector assembly according to claim 7, wherein the outer side wall on which the at least first gear wheel element and the at least second gear wheel element are mounted comprises a first hole, which is elongated following an elongation axis, and a rotation point or second hole located at a distance from the first hole in a direction of the elongation axis, wherein the at least one first gear wheel element comprises a rotation pin, extending through the first elongated hole and the at least one second gear wheel element is associated to a rotation pin extending through or from the second hole, and wherein the sets of first gear teeth of first and second gear wheel elements are in meshing engagement when the first gear wheel element is mounted at a first end of the elongated hole and out of engagement when the first gear wheel element is mounted at a second end of the elongated hole.

9. The electrical connector assembly according to claim 6, wherein the at least one first and optionally the at least one second gear wheel element is connected to the inner side of the outer side wall by means of a respective rotation pin defining a rotation axis of the gear wheel element, wherein the rotation pin is integral with the inner side of the outer side wall.

10. The electrical connector assembly according to claim 9, wherein the outer side wall on which the at least first gear wheel element and the at least second gear wheel element are mounted comprises a first hole, which is elongated following an elongation axis, and a rotation point or second hole located at a distance from the first hole in a direction of the elongation axis, wherein the at least one first gear wheel element comprises a rotation pin, extending through the first elongated hole and the at least one second gear wheel element is associated to a rotation pin extending through or from the second hole, and wherein the sets of first gear teeth of first and second gear wheel elements are in meshing engagement when the first gear wheel element is mounted at a first end of the elongated hole and out of engagement when the first gear wheel element is mounted at a second end of the elongated hole.

11. The electrical connector assembly according to claim 6, wherein the at least one first and optionally the at least one second gear wheel element is connected to the inner side of the outer side wall by means of a respective rotation pin defining a rotation axis of the gear wheel element, wherein the rotation pin is a separate element connected to the gear wheel element and to the inner side of the outer side wall.

12. The electrical connector assembly according to claim 11, wherein the outer side wall on which the at least first gear wheel element and the at least second gear wheel element are mounted comprises a first hole, which is elongated following an elongation axis, and a rotation point or second hole located at a distance from the first hole in a direction of the elongation axis, wherein the at least one first gear wheel element comprises a rotation pin, extending through the first elongated hole and the at least one second gear wheel element is associated to a rotation pin extending through or from the second hole, and wherein the sets of first gear teeth of first and second gear wheel elements are in meshing engagement when the first gear wheel element is mounted at a first end of the elongated hole and out of engagement when the first gear wheel element is mounted at a second end of the elongated hole.

13. The electrical connector assembly according to claim 1, wherein the gear wheel elements comprise a set of second gear teeth adapted for meshing with a teethed protrusion of an electrical counter-connector assembly, wherein optionally the second gear teeth can comprise one full tooth and two halve teeth.

14. The electrical connector assembly according to claim 1, wherein the sealed connector housing includes a seal at least partially arranged in the gap to create a tight, sealed connection with the counter-connector assembly when the connector assemblies are mated.

15. The electrical connector assembly according to claim 1, wherein the seal surrounds the connector housing at a location designed to receive an end region of the counter-connector assembly.

16. The electrical connector assembly according to claim 1, wherein the gap of the side wall has a substantially rectangular cross-section and is open towards a bottom and a top of the gap.

17. A mating assembly, comprising:
the electrical connector assembly according to claim 4; and
a counter-connector assembly, configured to be mated with the electrical connector assembly to create an electrical connection.

18. The mating assembly according to claim 17, wherein the counter-connector assembly comprises teethed racks that mesh with first sets of second gear teeth of the first gear wheel elements.

19. The mating assembly according to claim 17, wherein the counter-connector assembly comprises teethed racks that mesh with second sets of second gear teeth of the second gear wheel elements.

20. The mating assembly according to claim 17, wherein the gap of the connector housing accommodates the gear wheel elements, and wherein the remaining clearance within said gap basically corresponds to a thickness of the walls of the counter-connector assembly, such that the counter-connector assembly is fittingly mated with the connector assembly.
